(19) United States
(12) Patent Application Publication
(10) Pub. No.: US 2014/0086679 A1
(43) Pub. Date: Mar. 27, 2014

(54) CONNECTION OF A SHAFT PIECE OF A STEERING SHAFT FOR A MOTOR VEHICLE BY MEANS OF A CONNECTION PART

(71) Applicants: Robert Galehr, Mauren (LI); Erwin Bartholet, Flums (CH)

(72) Inventors: Robert Galehr, Mauren (LI); Erwin Bartholet, Flums (CH)

(21) Appl. No.: 14/122,829

(22) PCT Filed: Apr. 26, 2012
(86) PCT No.: PCT/AT2012/000113

§ 371 Date: Nov. 27, 2013

(30) Foreign Application Priority Data
May 31, 2011 (DE) 10 2011 050 748.5

(51) Int. Cl. F16D 1/08

(52) U.S. Cl. CPC F16D 1/08
USPC 403/374.2

(57) ABSTRACT

The connection of a shaft piece of a steering shaft for a motor vehicle by a connection part includes an accommodating opening, which is bounded by a wall and in which a connecting section of the shaft piece is fastened. A gap interrupts the wall bounding the accommodating opening and is arranged between first and second clamping sections of the connection part, which clamping sections each form a respective section of the wall bounding the accommodating opening that is adjacent to the gap. The first and second clamping sections can be drawn together by a clamping part such as to narrow the gap, and can be pressed against the connecting section to lock the connecting section to the connection part in order to close the connection.

### BACKGROUND OF THE INVENTION

The invention relates to a connection of a shaft piece of a steering shaft for a motor vehicle, with a mating component having a common longitudinal center axis with the shaft piece and which comprises a receiving aperture, delimited by a wall, through which extends the longitudinal center axis and into which a connection segment of the shaft piece is fixed in place, and a gap or slot which intercepts the wall delimiting the receiving aperture and is located between first and second clamping sections of the mating component, each of which forms a section, adjoining the gap, of the wall delimiting the receiving aperture. For closing the connection, the first and second clamping sections can be pulled together by a clamping part while narrowing the gap and, for tightening the connection segment with the mating component, can be pressed onto the connection segment. The wall delimiting the receiving aperture comprises form closure elements and the outer surface of the connection segment of the shaft piece comprises counter-form closure elements which cooperate with the form closure elements of the wall delimiting the receiving aperture. Through the cooperating form closure elements and counter-form closure elements a form closure, counteracting the turning of the connection segment of the shaft piece with respect to the mating component, is developed between the outer surface of the connection segment of the shaft piece and the wall delimiting the receiving aperture. In the closed state of the connection, the clamping sections tighten at least one of the form closure elements with at least one of the counter-form closure elements.

Such a connection serves especially for the securement of a joint yoke of a universal joint on an end section of a shaft piece of the steering shaft. The steering shaft herein comprises two or more shaft pieces which are connected via universal joints whose joint yokes are fixed in place on the shaft pieces. The mating component could, instead, also be, for example, a shaft extension or a pinion, fixed on the shaft piece, of the steering gearing.

Connections of universal joint yokes with shaft pieces are known in diverse forms. Yoke connections with slotted yokes, whose slot or gap can be pulled together by a clamping part, are disclosed, for example, in US 2010/0069163 A1 and EP 1 064 467 B1. In the case of the yoke connections disclosed in these publications, a yoke base in whose receiving aperture an end section of the shaft piece is received, comprises a gap on both sides of which clamping sections of the yoke base are located. The clamping sections include aligned through-passages through which a clamp bolt extends. By means of the clamp bolt the clamping sections are pulled together decreasing the gap in order to tighten the yoke base against the shaft piece.

In steering systems with booster assistance which is introduced into the steering shaft, the steering shaft must be capable of transmitting very high torques and especially very high torque peaks. The conventionally developed yoke connections of said type located in the transmission path of the torque must herein be laid out highly robustly in order to enable the transmission of the required torques without the clamping sections of the yoke base being bent open.

In the shaft-yoke connection disclosed in DE 10 2008 015 738 A1, a clamping part is provided that is disposed in a bore developed in the yoke base and located at right angles to the axis of the steering shaft. This bore includes a region of crossover with which intersects the receiving aperture, receiving the shaft end, of the yoke base. The clamping part includes a key surface with which it is in contact on a flat portion introduced into the shell surface of the shaft piece and is tightened against this flattening using a clamp bolt. The clamping part, consequently, acts as a feather key and the transmission of the torque acting between the shaft piece and the joint yoke takes place across this clamping part. Onto the wall of the bore receiving the clamping part thus acts a high hole-bearing stress. In order for it to be absorbed, the design must be developed correspondingly robust.

Further yoke-shaft connections in which an end section of the steering shaft is pressed into the receiving aperture of the yoke base are also known. Hereby, a form closure is formed in the rotational direction via a nonround form of the end section of the shaft and the receiving aperture of the yoke base or via a toothing on the end section of the shaft which, when pressed in, carves into the wall encompassing the receiving aperture. The toothing can also be disposed on the wall encompassing the receiving aperture. Such yoke connections are disclosed, for example, in U.S. Pat. No. 5,090,834 A, DE 2 651 338 A1, DE 2 333 040 A1 and WO 2008/049139 A1. A disadvantage is that the connection between the shaft piece and the joint yoke must already take place before the mounting of the steering column into the motor vehicle, whereby considerable difficulty can result in mounting the steering column in the motor vehicle. In addition, the shaft-yoke connection cannot subsequently be undone, for example, within the context of maintenance work.

DE 11 2008 001 042 T5 discloses a yoke connection of the type described in the introduction. The mating component includes clamping sections between which a gap is located and which are pulled together by a clamp bolt. A section of the clamp bolt is here received by an indentation of the shaft piece. According to a depicted embodiment, the shaft piece and the mating component comprise form closure elements cooperating with one another, which are formed by toothings which, apart from the region of the indentation of the shaft piece, encompass the shaft piece and the receiving aperture of the mating component. At a site opposite the clamp bolt, furthermore, is provided a trapezoidal projection on the shaft piece which is received in a trapezoidal indentation of the mating component. The rotational position of the shaft piece is thereby uniquely defined.

In the connection disclosed in EP 1 544 489 A1, the mating component formed by the universal joint yoke, which component is slotted, and the shaft piece also comprise cooperating form closure elements. In one embodiment, cooperating toothings are provided. In another embodiment, flattenings are provided on both sides with convexities provided in the proximity of these flattenings.

A slotted yoke with form closure elements is also disclosed in JP 2010-281364 A. The cooperating form closure elements of the yoke and of the shaft piece are implemented in the form of encompassing toothings.

The invention addresses the problem of providing a connection of the type discussed in the introduction between a shaft piece of a steering shaft and a mating component, which can absorb very high torques, such as occur in particular in booster-assistance steering mechanisms whose booster assistance engages into the upper region of the steering shaft. The material usage required for the mating component is to be low and the required constructed size or available space is to be as small as possible.

This is attained according to the invention through a connection with the features described herein. In the succeeding claims, advantageous embodiments of the invention will be represented.

In a connection according to the invention, the wall delimiting the receiving aperture comprises form closure elements and the outer surface of the connection segment, received in the receiving aperture, of the shaft piece comprises counter-form closure elements which cooperate with the form closure elements of the wall delimiting the receiving aperture. Through the cooperating form closure elements and counter-form closure elements, a form closure is developed between the outer surface of the connection segment and the wall delimiting the receiving aperture, which form closure counteracts a turning out of position of the connection segment with respect to the mating component. In the closed state of the connection, the clamping sections of the mating component, between which the gap of the mating component is located and which are tightened toward one another by the clamping part, tighten at least one of the form closure elements with at least one of the counter-form closure elements, preferably all form closure and counter-form closure elements engaging one into the other.

The clamping part is formed in particular by a clamp bolt which is at least partially disposed in bores in the clamping sections of the mating component.

In the closed state of the connection, the clamping part is preferably spaced apart from the connection segment of the shaft piece. The force introduction, with the aid of which the counter-form closure elements of the connection segment of the shaft piece are pressed under stress into engagement with the form closure elements, is carried out via at least two surface sectors of the wall of the receiving aperture. These surface sectors are on the same side of the receiving aperture as the clamping part. It is conceivable and feasible to provide more than two surface sectors which transmit the force for the establishment of the engagement onto the connection segment.

Through the form closure elements, which are comprised by the wall delimiting the receiving aperture, such has a cross-sectional shape differing from the circular shape. As form closure elements can act, for example, surfaces which are formed by at least one elevation extending in the axial direction of the shaft piece, preferably several such elevations, and/or at least one indentation extending in the axial direction of the shaft piece, preferably several such indentations. Instead, or in addition, surfaces can, for example, be provided which, viewed in cross section, are developed in the form of geometric chords introduced into a circle shape.

In the connection according to the invention the forces occurring through torque transmission are primarily transmitted via the form closure elements of the wall delimiting the receiving aperture and the counter-form closure elements of the connection segments, which elements are in engagement, and are not transmitted through a friction closure connection between the shaft piece and the mating component. The force (in addition to the prestress force) acting additionally onto the at least one clamping part in the transmission of a torque is substantially lower than the force overall acting onto the form closure elements.

Preferred is that at least one form closure element, which in the closed state of the connection is tightened with one counter-form closure element, is located in a region opposite the gap, thus in a region whose angular distance, referred to the rotational angle about the longitudinal center axis of the shaft piece and of the mating component, from the gap is 180°±10°. Into this at least one form closure element, the counter-form closure element cooperating therewith is pressed under stress during the closure of the connection.

According to the invention, all form closure elements, which in the closed state of the connection are tightened with one counter-form closure element, are disposed in an angular region which is spaced apart by at least 100° from the gap located between the clamping sections in both rotational directions about the longitudinal center axis of the shaft piece and of the mating component. This means in an angular region extending over at least 100° in both rotational directions about the longitudinal center axis of the shaft piece or the mating component adjoining the gap, there are no cooperating form closure elements and counter-form closure elements (in this angular region no form closure elements and counter-form closure elements at all can be provided; however, there could also be provided form closure elements which do not cooperate with a counter-form closure element or conversely).

It can in this way be attained that, in the transmission of high torques via the connection, only low forces are introduced into the clamping part clamping together the clamping sections. The slotted mating component is thereby not stressed so highly during the transmission of high torques that the gap is bent open through the high torques.

In an advantageous embodiment of the invention, the mating component is a universal joint yoke that comprises arms with bearing openings and a yoke base from which project the arms.

### BRIEF DESCRIPTION OF THE DRAWINGS

Further advantages and details of the invention will be explained in the following in conjunction with the attached drawings, in which:

FIG. 1 is a schematic depiction of a feasible implementation of a steering system with booster assistance;

FIG. 2 is an oblique view of a universal joint with first and second joint yokes connected with a particular shaft piece;

FIG. 3 is an oblique view of one of the joint yokes with the joint cross without a connected shaft piece and without a clamping part, from a different viewing angle;

FIG. 4 shows a cross section through the joint yoke and the connection segment of the shaft piece introduced into the receiving aperture, in the opened state of the connection;

FIG. 5 shows a cross section corresponding to FIG. 4, in the closed state of the connection (section line AA of FIG. 2);

FIG. 6 shows a modified embodiment;

FIG. 7 shows a further modified embodiment;

FIG. 8 shows a further modified embodiment.

### DETAILED DESCRIPTION OF THE INVENTION

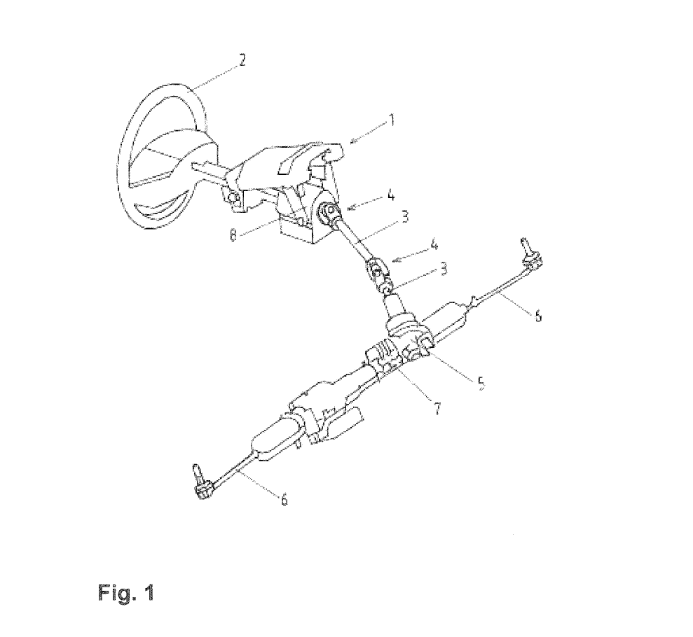

The fundamental structure of the steering column 1 shown schematically in FIG. 1 corresponds to the prior art. For the transmission of the steering movements of a steering wheel 2 serves a steering shaft comprising two or more straight shaft pieces 3 between which is located in each instance a universal joint 4. The steering shaft is connected with the steering links 6 via a steering gearing 5, wherein the steering links 6 are driven by a toothed rack 7.

The steering column comprises further, for example, an electric auxiliary drive 8 from which can be exerted onto the steering shaft a torque that is transmitted via the universal joints 4 disposed between the auxiliary drive 8 and the steering gearing 5 in the steering shaft.

As is conventional, the auxiliary drive 8 can be provided for applying a steering booster and/or for the superposition of rotational speeds. Relevant gearings between the auxiliary drive 8 and the steering shaft (not visible in FIG. 1) serve for this purpose. Depending on implementation and application, a control apparatus, also not depicted, can be provided to which is supplied the actuation of the steering wheel 2 via an electronic sensor system as a signal. In the control apparatus, possibly with a driving dynamics data processor, therefrom can be determined, if appropriate, with the aid of a sensor signal of the auxiliary drive of the steering system and/or of the rotational speed superposition device and/or further signals describing the motor vehicle status, the corresponding control signal, for example a control voltage, for the auxiliary drive and be output thereto.

Each universal joint 4 comprises first and second joint yokes which in each instance form a mating component 9 connected to the particular shaft piece 3. For at least one of the shaft pieces 3 the connection with the associated mating component 9 is implemented in the manner according to the invention. Preferably, at least in all of the universal joints 4 via which the torque exerted by the auxiliary drive 8 is transmitted and which, for example for purposes of installation, should be disconnectable, the connections of the shaft pieces 3 with the mating component 9 are developed in the manner according to the invention.

A relevant joint yoke forming a mating component 9 is implemented in side view in the shape of a U and comprises two arms 10, 11 projecting from a yoke base (=yoke head) 12. The arms 10, 11 are located in planes spaced apart from one another and preferably at least approximately parallel (the angle between the planes is less than 5°.

For the connection of the joint yokes of a universal joint serves a joint cross 13 comprising joint pins offset by 90° with respect to one another. In each instance the two joint pins offset by 180° with respect to one another, whose longitudinal axes coincide, are rotatably bearing supported opposite one of the two joint yokes. For this purpose, the joint pins project into a bearing opening 14 of the particular arm 10, 11 and are rotatably bearing supported therein.

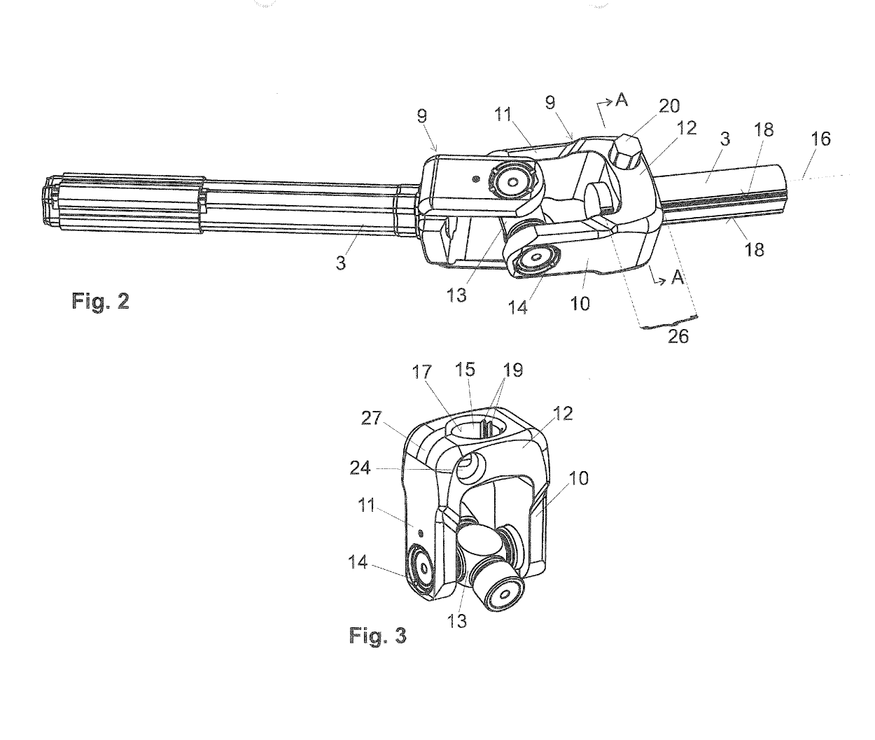

A first embodiment according to the invention of the connection between a shaft piece 3 and a mating component 9 is evident in FIG. 2 to 5.

A section of the mating component 9, in the depicted application case the yoke base 12, includes a receiving aperture 15 in which is received a connection segment 26 of the shaft piece 3 forming here an end section of the shaft piece 3. In the embodiment, the receiving aperture 15 is developed as a through opening through the mating component 9, here the yoke base 12.

The longitudinal center axis 16 of the straight shaft piece 3 coincides with the longitudinal center axis of the mating component 9 which axis extends through the receiving aperture 15.

The receiving aperture 15 of the mating component 9 is delimited in the radial direction by a wall 17 of mating component 9, which is intercepted by a gap 27. The gap 27 is located between clamping sections 12a, 12b of mating component 9, here the yoke base 12. Each of the clamping sections 12a, 12b forms a section, adjoining the gap 27, of the wall 17 delimiting the receiving aperture 15.

In the closed state of the connection the clamping sections 12a, 12b are acted upon (pulled together) by a clamping part 20 in the direction toward one another. As the clamping sections 12a, 12b are considered those sections adjoining the gap 27 of the mating component 9 (here the yoke base 12 of the joint yoke) that are deformed, thus are bent inwardly (in the direction toward the other clamping section), during the closing of the connection.

In the embodiment, the clamping part is formed by a clamp bolt penetrating a bore 24 in the clamping section 12a and machine-screwed into an internal thread of a bore 25 introduced into the clamping section 12b. The bores 24, 25 are aligned with one another and their longitudinal center axes are preferably at right angles to the longitudinal center axis 16 of shaft piece 3. In principle conceivable and feasible would also be an oblique disposition with respect to the longitudinal center axis 16 of the shaft piece 3.

In the wall 17 encompassing the receiving aperture 15 form closure elements 18 are developed. These cooperate with counter-form closure elements 19 that are developed on the outer surface of the shaft piece 3 at least in a region of its connection segment 26 received in the receiving aperture 15.

The form closure and counter-form closure elements 18, 19 tightened together with one another establish a form closure acting in the rotational direction between the shaft piece 3 and the mating component 9, which means a form closure is established counteracting a turning out of position of the connection segment 26 of the shaft piece 3 with respect to the mating component 9 about the longitudinal center axis 16.

In the closed state of the connection, the clamping sections 12a, 12b are pressed onto the connection segment 26 through the clamping part 20 that is under prestress. Thereby counter-form closure elements 19 of the connection segment 26 located in an angular region 28 about the longitudinal center axis 16 are tightened with form closure elements 18 of wall 17. The angular region 28 is spaced apart from the gap 27 in both rotational directions about the longitudinal center axis 16 by angles 29, 30, each of which is at least 100°. All of the form closure elements and counter-form closure elements in engagement with one another are located in this angular region (the form closure elements angular region) 28.

The angles 29, 30 are thus the (positive and negative) polar angles of the polar coordinate system referred to the longitudinal center axis. In this system of polar coordinates the gap 27 extends over a certain angular region. The angular region 28, in which all form closure elements and counter-form closure elements 18, 19 tightened together are disposed, is spaced apart from the polar angular region in which the gap is located by a positive and a negative polar angle of at least 100° each.

The circumference about the connection segment 26 is consequently advantageously divided into at least largely opposing regions in which, on the one hand, the clamping force is transmitted from the clamping sections 12a, 12b onto the connection segment 26 and, on the other hand, the form closure between the connection segment 26 and the mating component 9 takes place.

In the depicted embodiment, the transmission of the clamping force from the clamping sections 12a, 12b onto the connection segment 26 takes place through edges located between a particular section, adjoining the gap 27, of wall 17 and a particular wall 31, 32 delimiting the gap 27. These edges are pressed onto the connection segment 26 and press it against the section of wall 17 opposite gap 27. Onto the form closure elements 18 of wall 17 are thereby pressed the counter-form closure elements 19 cooperating therewith of connection segment 26.

In the embodiment, a section of wall 17 adjoining said edges is spaced apart from the connection segment 26 whereby in each instance a crevice 23 is formed between the connection segment 26 and the wall 17.

It can also be provided in a modified embodiment for the sections of wall 17 adjoining both sides of the gap 27, which sections are formed by the clamping sections 12a, 12b, to each be pressed against the connection segment 26. On the side remote from the gap 27 adjoining these pressed-on sections could, again, be located a crevice 23 between the connection segment 26 and the wall 17.

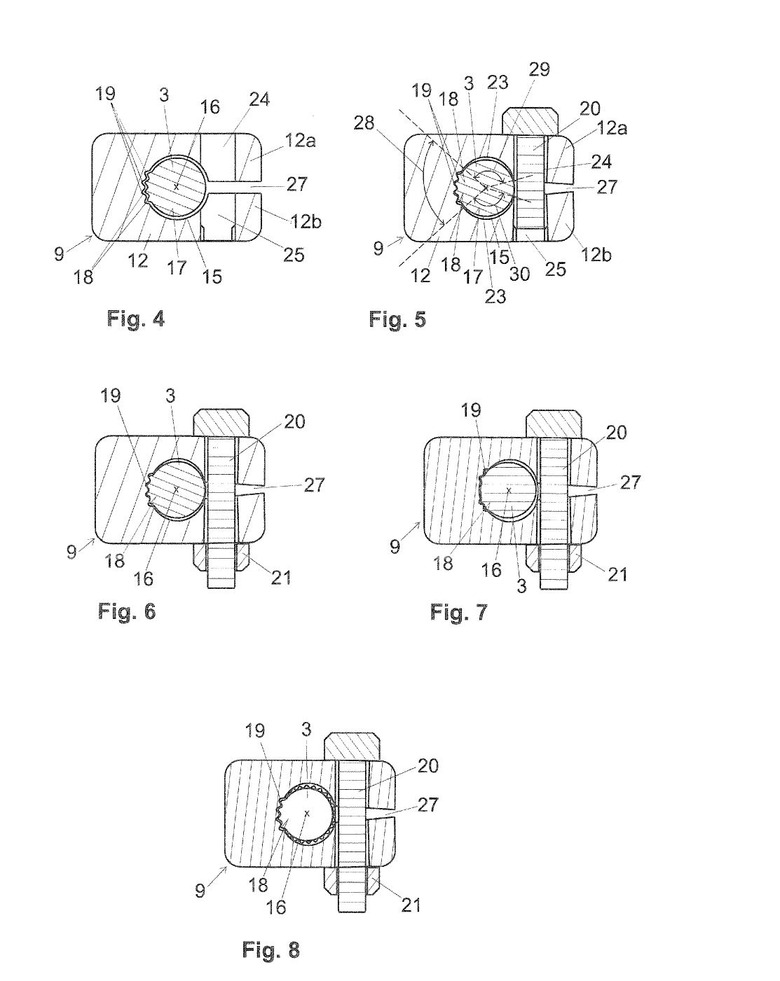

In the opened state of the connection depicted in FIG. 4, the connection segment 26 is axially insertable into the receiving aperture 15 and removable therefrom.

To close the connection, the first and second clamping sections 12a, 12b are pulled together by the clamping part 20, in the process of which the gap 27 narrows. In the example according to FIG. 5, the clamping part 20 is machine-screwed into a threaded section on the clamping section 12b and tightened. The sections, formed by the clamping sections 12a, 12b, of wall 17 move inwardly (in the direction toward the longitudinal center axis of shaft piece 3). The diameter of the receiving aperture 15, consequently, decreases in the corresponding directions.

In the closed state of the connection, the width of gap 27 is less than in the opened state. Clamping part 20 is prestressed with a prestress force. The clamping sections 12a, 12b are pulled together by the edges, located between wall 17 and the particular wall 31, 32, or sections of wall 17 adjoining on both sides the gap 27 are pressed onto the connection segment clamping part 20, and tighten the connection segment 26 with the mating component 9 under tightening of the form closure elements 18 and the counter-form closure elements 19.

The counter-form closure elements 19 of shaft piece 3 are, for example as shown, formed by the side faces of several tooth-shaped elevations extending in the longitudinal direction of the shaft piece 3. For the formation of form closure elements 18, the wall 17 comprises indentations extending in the longitudinal direction of shaft piece 3 and preferably conically tapering when viewed in cross section through the shaft piece 3. In the embodiment, four such elevations and indentations are provided.

Form closure elements and counter-form closure elements 18, 19 developed in a different manner could also, or additionally, be provided. For example, indentations extending in the longitudinal direction of shaft piece 3 could be provided in the connection segment 26 of shaft piece 3, which indentations cooperate with elevations, extending in the longitudinal direction of the shaft piece 3, of wall 17 of the receiving aperture 15 and/or flattenings or flutes or other contours could be provided which develop a cross sectional shape deviating from a circular shape.

The form closure elements of wall 17 of the receiving aperture 15 can be developed in simple manner through a stripping operation. Forming them in during the reforming operation for the production of the yoke is also feasible. The counter-form closure elements 19 of connection segment 26 of the shaft piece 3 can also be formed, for example, through a milling or knurling operation.

FIG. 6 to 8 depict modified embodiments. Apart from the difference described in the following, the implementation corresponds to that of the previously described embodiment.

In the embodiment variants of FIG. 6, the bores 24 and 25 are developed as aligned through-openings through the clamping sections 12a, 12b and the clamping part 20 implemented as a clamp bolt penetrates through these and is tightened by a clamping nut 21 machine-screwed onto an outer threading of the section, projecting from bore 25, of the clamp bolt.

FIG. 7 depicts a feasible modification of a disposition of form closure elements 18 and counter-form closure elements 19.

In addition to the counter-form closure elements 19 engaged with the form closure elements 18, the connection segment 26 of the shaft piece 3 can also comprise further, for example, tooth-shaped elevations and/or, for example, tooth-shaped indentations, flattenings or other developments of its outer surface through which a cross sectional shape differing from a circular shape of the connection segment 26 is formed. These further elements (through which in principle a form closure acting in the rotational direction could be developed) are not in engagement with the preformed form closure elements 18 in wall 17 of the receiving aperture 15. FIG. 8 depicts such a modified implementation in which the connection segment 26 includes an encompassing toothing. An encompassing toothing of the connection segment 26 of the shaft piece 3 can be formed, for example, by knurling. The teeth, opposite gap 27, of shaft piece 3, which form counter-form closure elements 19 come into engagement with the form closure elements 18 located there, of mating component 9. The remaining teeth do not come into form-closure engagement, or at least not substantially, with the wall 17 of mating component 9. The teeth not coming into engagement with the form closure elements 18 are herein more or less flattened-off through the clamping part 20 during the tightening. Through these teeth a frictional closure is formed between the connection segment 26 and the wall 17.

In the embodiment depicted in FIG. 8, the teeth in engagement with the form closure elements 18, which form the counter-form closure elements 19, are shown as being implemented to be larger than the remaining teeth. However, all of the teeth could also be implemented of equal size.

In a modified implementation, it is also conceivable and feasible that the peaks of at least the teeth located in the proximity of the preformed form closure elements 18 carve more or less into the wall 17, whereby during the tightening further form closure elements are formed which are in engagement with counter-form closure elements of the shaft piece and develop a form closure acting in the rotational direction. However, over angles 29, 30 of 100°, no form closure and counter-form closure elements are provided on both sides adjoining the gap 27 that are in engagement under form closure.

During the tightening of the connection segment 26 with the mating component 9 by means of the at least one clamping part it is entirely possible for plastic deformations, in particular of the counter-form closure elements and/or of the form closure elements, to occur whereby a tolerance-free form closure can be attained. Elastic residual stresses can herein advantageously sustainably secure the form closure even at high varying stresses.

It can advantageously be provided that the form closure elements and the counter-form closure elements, even with an opened or dislodged clamping part, are unable to come entirely out of engagement (as long as the engagement is not abrogated through an axial shift of the shaft piece with respect to the mating component).

Through the high prestress force to which the clamping part 20 is subject, a secure and firm seating of the connection segment 26 in the mating component 9 can be attained which, even under high varying stresses, does not become detached by self actuation.

Connection parts other than joint yokes, for example a steering pinion, can also be connected in the described manner with a shaft piece of the steering shaft.

A connection according to the invention can advantageously without destruction be closed and opened again repeatedly, in particular by means of a rotating tool.

### LEGEND TO THE REFERENCE NUMBERS

1 Steering column
2 Steering wheel
3 Shaft piece
4 Universal joint
5 Steering gearing
6 Steering link
7 Toothed rack
8 Auxiliary drive
9 Mating component
10 Arm
11 Arm
12 Yoke base
12a Clamping section
12b Clamping section
13 Joint cross
14 Bearing opening
15 Receiving aperture
16 Longitudinal center axis
17 Wall
18 Form closure element
19 Counter-form closure element
20 Clamping part
21 Clamping nut
23 Crevice
14 Bore
25 Bore
26 Connection segment
27 Gap
28 Angular region
29 Angle {of Connection sector 29}
30 Angle {of Connection sector 30}
31 Wall
32 Wall

1. A connection between a shaft piece of a steering shaft for a motor vehicle, and a mating component having a common longitudinal center axis with the shaft piece;
the shaft piece including a connection segment with an outer surface;
the mating component including a receiving aperture, delimited by a wall, through which the longitudinal center axis extends and in which a connection segment of the shaft piece is fixed in place, a a first clamping section and a second clamping section, each of which forms a section of the wall delimiting the receiving aperture, and a gap formed to intercept the wall of the receiving aperture, and located between the first clamping section and the second clamping section of the mating component, the first clamping section and the second clamping section each forming a section of the wall adjoining the gap; and
wherein the wall delimiting the receiving aperture comprises form closure elements, and the outer surface of the connection segment of the shaft piece comprises counter-form closure elements which cooperate with the form closure elements of the wall delimiting the receiving aperture,
wherein the cooperating form closure elements and the counter-form closure elements are configured to define a form closure between the outer surface of the connection segment and the wall delimiting the receiving aperture for counteracting a turning out of position of the connection segment of the shaft piece with respect to the mating component,
the connection further comprising a clamping part for closing the connection by pulling the first clamping section and the second clamping section together so as to narrow the gap, and for tightening the connection segment with the mating component by pressing the first clamping section and the second clamping section onto the connection segment;
wherein in the closed state of the connection, the clamping sections tighten at least one of the form closure elements together with at least one of the counter-form closure elements, and
wherein all form closure elements tightened with a particular one of the counter-form closure elements in the closed state of the connection are disposed in an angular region spaced apart from the gap between the first clamping section and the second clamping section in both rotational directions about the longitudinal center axis by angles of at least 100° in each instance.

2. The connection as in claim 1, wherein, in the closed state of the connection, edges located between the particular section adjoining the gap of the wall delimiting the receiving aperture and a particular wall adjoining the gap, or the sections adjoining the gap, of the wall delimiting the receiving aperture are pressed onto the connection segment, and press the latter against a section, opposite the gap, of the wall delimiting the receiving aperture.

3. The connection as in claim 1, wherein the mating component is a universal joint yoke comprising arms with bearing openings and a yoke base from which project the arms.

4. The connection as in claim 1, wherein the clamping part is formed as a clamp bolt.

5. The connection as in claim 1, wherein the clamping part is in the closed state of the connection is not in contact with the surface of the shaft piece.

6. The connection as in claim 2, wherein the mating component is a universal joint yoke comprising arms with bearing openings and a yoke base from which project the arms.

7. The connection as in claim 2, wherein the clamping part is formed as a clamp bolt.

8. The connection as in claim 3, wherein the clamping part is formed as a clamp bolt.

9. The connection as in claim 2, wherein the clamping part in the closed state of the connection is not in contact with the surface of the shaft piece.

10. The connection as in claim 3, wherein the clamping part in the closed state of the connection is not in contact with the surface of the shaft piece.

11. The connection as in claim 4, wherein the clamping part in the closed state of the connection is not in contact with the surface of the shaft piece.
